(19) United States
(12) Patent Application Publication
(10) Pub. No.: US 2023/0166759 A1
(43) Pub. Date: Jun. 1, 2023

(54) SYSTEMS AND METHODS FOR IMPROVING LOCALIZATION ACCURACY BY SHARING DYNAMIC OBJECT LOCALIZATION INFORMATION

(71) Applicant: TOYOTA RESEARCH INSTITUTE, INC., Los Altos, CA (US)

(72) Inventors: HIROSHI YASUDA, San Francisco, CA (US); MANUEL LUDWIG KUEHNER, Mountain View, CA (US); ALEXANDER CHRISTOPH SCHAEFER, Heuweiler (DE)

(21) Appl. No.: 17/540,148

(22) Filed: Dec. 1, 2021

(51) Int. Cl. B60W 60/00; H04W 4/46

(52) U.S. Cl. CPC B60W 60/001; H04W 4/46; B60W 2554/4049; B60W 2420/52; B60W 2554/4041

(57) ABSTRACT

Systems and methods are provided for improving a localization estimate of a vehicle by leveraging localization estimates of surrounding dynamic objects from surrounding vehicles. A vehicle may estimate its own location relative to a global reference frame. The vehicle may identify nearby dynamic objects. The vehicle may estimate the location of the nearby dynamic objects. The vehicle and nearby vehicles may generate and exchange localization packets containing information about the dynamic objects and the location estimates for the dynamic objects. The vehicle may refine its localization estimate based on received localization packets.

### TECHNICAL FIELD

The present disclosure relates generally to systems and methods for improving the localization accuracy of an object, and in particular, some implementations may relate to leveraging localization estimates relative to dynamic objects to improve localization accuracy.

### DESCRIPTION OF RELATED ART

Accurately determining the location of a moving object on the road is an important task for many applications including, for example, navigation, advanced safety systems (ADAS), and autonomous driving. Localization can refer to determining both the position and the orientation of an object with respect to a reference. A reference may be a global reference. A global reference frame may refer to vehicle or dynamic object localization relative to a selected point on a map. For instance, a global reference frame may be relative to the origin of a selected map. A global reference frame may also be relative to the center of the Earth. Other global reference frames are possible.

Existing approaches to localization include satellite-based localization with base stations on the ground. For example, a base station may average GPS indications of the localization of a vehicle or vehicles over time to formulate a precise estimate of a vehicle or vehicles' location. Real time kinematic (RTK) positioning is an example of this kind of localization method that leverages a base station and one or more GPS receivers to determine a vehicle localization. The base station takes satellite measurements and then transmits the satellite measurements and its own location to the receivers. The receivers do the same. This approach is only effective, however, when a base station is nearby and available for communication.

Another existing approach to localization is map-based localization. This can be performed by detecting certain static landmarks and measuring a vehicle or vehicles' location relative to the landmark using sensors. Static landmarks my include poles, street signs, traffic signals, lane markings, and other physical markings and structures. Sensors may include LIDAR sensors and cameras. This approach only works when there is a pre-constructed map of an area available.

Both the map-based and satellite-base station approaches can be ineffective in certain environments, for example in an “urban tunnel” or other environments. That is because these approaches rely on connectivity and communication and/or the availability of a pre-constructed map with identified landmarks. Additionally, autonomous operation applications require a high degree of accuracy for localization compared to other applications, such as navigation. The above methods and other existing methods of localization may not achieve the type of high accuracy localization needed to support autonomous operation applications.

### BRIEF SUMMARY OF THE DISCLOSURE

According to various embodiments of the disclosed technology a method for improving localization accuracy of a target object may include estimating a location of a first vehicle relative to a global reference frame, detecting a dynamic object proximate to the first vehicle, estimating a location of the dynamic object relative to the location of the first vehicle, estimating a location of the dynamic object relative to the global reference frame based on the estimated location of the first vehicle, identifying a second vehicle proximate to the dynamic object, and receiving a localization packet from the second vehicle. The localization packet may be generated by the second vehicle based on the second vehicle's estimated location of the dynamic object and a time stamp associated with the second vehicle's estimated location of the dynamic object. The method may also include refining the estimate of the location of the target object.

In a method for improving localization accuracy of a target object, the target object may be the first vehicle. In a method for improving localization accuracy of a target object, refining the estimate of the location of the target object may include refining the estimate of the dynamic object based on the received localization packet and refining the estimate of the location of the first vehicle based on the refined estimate of the location of the dynamic object.

In a method for improving localization accuracy of a target object, the target object may be the dynamic object. In a method for improving localization accuracy of a target object, refining the estimate of the location of the target object may include refining the estimate of the location of the dynamic object based on the received localization packet.

In a method for improving localization accuracy of a target object, the dynamic object may be, for example, a pedestrian. For instance, a pedestrian may be walking along a road area on a sidewalk and nearby vehicles may pass the pedestrian at different times and may be able to detect the pedestrian when in proximity to the pedestrian. In another example, the dynamic object may be a cyclist. In another example, the dynamic object may be a vehicle. In a method for improving localization accuracy of a target object, a global reference frame may be relative to the origin of a selected coordinate plane. In another example of a method for improving localization accuracy of a target object, a global reference frame may be the center of the Earth.

A method for improving localization accuracy of a target object may also include generating a localization packet based on the first vehicle's estimated location of the dynamic object and a time stamp associated with the first vehicle's estimated location of the dynamic object and transmitting the generated localization packet to the second vehicle.

In a method for improving localization accuracy of a target object, transmitting the generated localization packet to the second vehicle may include transmitting the generated localization packet using vehicle-to-vehicle (V2V) communications. In another example of a method for improving localization accuracy of a target object, transmitting the generated localization packet to the second vehicle may include transmitting the generated localization packet using Wi-Fi.

A method for improving localization accuracy of a target object may also include performing an association for the dynamic object by estimating a location of the dynamic object relative to a global reference frame at a shared point in time based on the first vehicle's estimated location of the dynamic object and the time stamp associated with the first vehicle's estimated location of the dynamic object and the second vehicle's estimated location of the dynamic object and the time stamp associated with the second vehicle's estimated location of the dynamic object. In a method for improving localization accuracy of a target object, the generated and received localization packets may each contain identification information associated with the dynamic object. A method for improving localization accuracy of a target object may also include performing an association for the dynamic object by matching the identification information associated with the dynamic objected contained in the generated and received localization packets.

A method for improving localization accuracy of a target object may also include identifying additional vehicles proximate to the dynamic object, transmitting the generated localization packet to the additional vehicles, and receiving additional localization packets from each additional vehicle. Each additional localization packet may be generated, respectively, by each additional vehicle and is based on, respectively, each additional vehicle's estimated location of the dynamic object and a time stamp associated with each additional vehicle's estimate location of the dynamic object. The method may also include refining the estimate of the location of the target object.

A method for improving localization accuracy of a target object may also include determining which vehicle, among the first vehicle, second vehicle, and additional vehicles, is best equipped to accurately determine the location of the target object, affording greater weight to the localization estimate of the vehicle best equipped to accurately estimate the location of the target object, and refining the estimate of the location of the target object based on the weighted generated, received, and additional localization packets.

A method for improving localization accuracy of a target object may also include repeating the determination of which vehicle, among the first vehicle, second vehicle, and additional vehicles, is best equipped to accurately determine the location of the target object, affording greater weight to the localization estimate of the vehicle best equipped to accurately determine the location of the target object, and again refining the estimate of the location of the target object based on the weighted generated, received, and additional localization packets.

A localization system may include a first vehicle. The first vehicle may be equipped with advanced safety systems (ADAS), able to estimate its location, and able to communicate with other vehicles. A localization system may also include a dynamic object detected by the first vehicle as proximate to the first vehicle. A localization system may also include a second vehicle proximate to the dynamic object. The second vehicle may be equipped with ADAS, able to estimate its location, and able to communicate with other vehicles. The first vehicle may estimate a global location of the first vehicle, may estimate a first location of the dynamic object relative to the location of the first vehicle, and may estimates a global location of the dynamic object based on the global estimate location of the first vehicle and the first relative estimate of the dynamic object. The second vehicle may estimate a global location of the second vehicle, may estimate a second location of the dynamic object relative to the location of the second vehicle, and may estimate a global location of the dynamic object based on the global estimate location of the second vehicle and the second relative estimate of the dynamic object.

A localization system may also include a first localization packet. The first localization packet may be generated by the first vehicle based on the first estimated global location of the dynamic object and a first time stamp at which the first vehicle detected the dynamic object. A localization system may also include a second localization packet. The second localization packet may be generated by the second vehicle based on the second estimated global location of the dynamic object and a second time stamp at which the second vehicle detected the dynamic object. The first and second vehicles may exchange the first and second localization packets. The first and second vehicles may each refine their estimated global locations for both the first vehicle and the second vehicles, respectively, and the dynamic object based on the received localization packets.

In a localization system, the estimated global locations of the first and the second vehicles and the dynamic object, including the first and second localization packets, may each include an uncertainty range. In a localization system, the first and second vehicles may take the uncertainty ranges into account in refining their estimated global locations for the first vehicle and the second vehicle, respectively, and the dynamic object based on the received localization packets.

A localization system may also include GPS receivers. The GPS receivers may support real-time kinematic (RTK) positioning. The system may cross reference localization packets with localization estimates determined by the GPS receivers to refine localization estimates. A localization system may also include pre-constructed maps of driving areas. The pre-constructed maps may support relative localization estimates. The system may cross reference localization packets with localization estimates performed by referencing the pre-constructed maps.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for leveraging localization estimates of nearby dynamic objects to improve localization accuracy of a vehicle in accordance with one embodiment of the systems and methods described herein.

FIG. 3 is an example computing component that may be used to implement various features of embodiments described in the present disclosure.

FIG. 4 is an example of a method for improving vehicle localization accuracy.

FIG. 5 is an example of a localization packet.

FIG. 6 is an example of localization improvement system including two vehicles and a dynamic object.

FIG. 7 is an example of a localization improvement system including multiple vehicles and a dynamic object.

The figures are not exhaustive and do not limit the present disclosure to the precise form disclosed.

### DETAILED DESCRIPTION

Embodiments of the systems and methods disclosed herein are directed to improving localization accuracy of an object. Localization may refer to both a vehicle or vehicles' position and orientation relative to a reference. As discussed above, localization can refer to determining both the position and the orientation of an object with respect to a reference. In some embodiments described in the vehicular context, localization may refer to the position and/or orientation of a vehicle in a global reference frame. A global reference frame may refer to vehicle or dynamic object localization relative to a selected point on a map. For instance, a global reference frame may be relative to a position on a map, such as the origin of a map. A global reference may also be relative to a position in the physical world, such as the center of the Earth. Accurate localization is important for several vehicle applications including navigation, advanced driver safety systems (ADAS), and autonomous driving. In particular, autonomous driving requires highly precise and localization in order to be effective and valuable.

Improving localization of a vehicle in embodiments can be achieved by leveraging localization estimates relative to dynamic objects sensed by a nearby vehicle or a plurality of surrounding vehicles. Specifically, the embodiments disclosed herein leverage the localization estimates relative to a dynamic object of two or more vehicles that can each perceive a dynamic object to improve one or more of the vehicles' localization estimates. Vehicles that can perceive each other and/or a dynamic object may be located close to each other geographically, such as in the same physical driving area. Vehicles may have different orientations and positions relative to each other and/or nearby dynamic objects, such as head-on, parallel, following, adjacent, and other types of orientations. Vehicles may also move at different speeds relative to each other and/or nearby dynamic objects. For these reasons, the degree of accuracy with which a particular vehicle is capable of performing a localization by estimating the relative location of a dynamic object may vary.

In an embodiment, the systems and methods disclosed herein rely only on two or more vehicles' ability to perceive dynamic objects. Therefore, specialized infrastructure, such as RTK base stations and/or pre-constructed maps are not necessary in order to perform highly accurate localization on part with traditional methods. This may be advantageous in particular situations. For example, in one embodiment, vehicles may be traveling in a dense urban area, such as an “urban tunnel.” Many vehicles and dynamic objects, such as pedestrians, bicycles, and other vehicles, may be present. Many vehicles may be available within a given area and may be able to perceive each other and to communicate with one another. However, satellite-based localization may be unavailable or inaccurate due to the obstruction and reflection of signals by some physical object or objects. For instance, a dense urban area with many dense and/or tall buildings, such as skyscrapers, may obstruct the signal. Additionally, such an area may undergo near constant development and up-to-date pre-constructed maps may not be available. Further, even if such maps do exist, due to the potential for signal obstruction, vehicles many not be able to access such maps in sufficient time to perform the kind of high accuracy localization needed for autonomous driving applications.

In another embodiment, the systems and methods for improving localization by leveraging relative dynamic object localization estimates may be combined with existing methods such as RTK base stations and/or pre-constructed maps. For example, vehicle may pass near an area with reduced signal. When the signal is unavailable, the dynamic object localization approach may be used but when vehicles are connected again, a pre-constructed map may be updated.

In an embodiment of the systems and methods disclosed herein, vehicles may exchange localization estimates relative to dynamic objects anonymously. For instance, exchanged localization estimates may not include an absolute location of a vehicle in the physical world. Rather, localization packets may include a localization of estimate for a mutually observed dynamic object relative to a reference, such as the origin of a selected map. Therefore, when vehicles exchange localization packets, they exchange localization estimates of dynamic objects relative to this point such that either vehicle is able to determine, assess, and improve a relative localization estimate based on the dynamic object estimate but neither vehicle is estimating or storing an absolute location. This allows vehicles to employ the systems and methods disclosed herein anonymously.

In one embodiment, a subject vehicle or ego vehicle may improve a localization estimate for itself. The ego vehicle may be an autonomous vehicle. The ego vehicle may improve a localization estimate for itself by leveraging localization estimates of dynamic objects of a nearby vehicle or surrounding vehicles. The ego vehicle may be equipped with advanced safety systems (ADAS). The ego vehicle may have the ability to estimate its location relative to a reference. The ego vehicle may have the ability to estimate the location of a dynamic object relative to a reference or relative to its own location estimate. The ego vehicle may also be able to communicate with other vehicles. A vehicle or vehicles nearby the ego vehicle may also be equipped with ADAS. The nearby vehicle or vehicles may also be able to estimate their locations relative to a reference. The nearby vehicle or vehicles may have the ability to estimate the location of a dynamic object relative to a reference or relative to their own location estimate. The nearby vehicle or vehicles may be able to communicate with other vehicles, including each other and/or the ego vehicle. In an embodiment, vehicles may communication through vehicle-to-vehicle (V2V) communications. In another embodiment, vehicles may communicate over wifi. In another embodiment, vehicles may alternatively or additionally communicate through vehicle-to-infrastructure (V2X) communication.

The ego vehicle and nearby vehicle and/or surrounding vehicles may be able to estimate their locations or the locations of dynamic objects relative to a global reference frame. A global reference frame may refer to vehicle or dynamic object localization relative to a selected point on a map. The selected point may be the origin of a coordinate system or any other point of interest on a coordinate system. The global reference frame may also refer to vehicle or dynamic object localization relative to a global location. For example, vehicle or dynamic object localization may be estimated relative to the center of the Earth. Vehicle or dynamic object localization may also be estimated relative to some other physical point selected on the Earth.

In another embodiment, the ego vehicle and nearby vehicle and/or surrounding vehicles may estimate their localizations relative to a global reference frame but may estimate the localization of a nearby dynamic object relative only to their own localization. The ego vehicle and each of the nearby vehicle and/or surrounding vehicles may perform their own estimates of the relative location of the dynamic object without the need to perceive each other directly and/or estimate the localizations of each other. The ego vehicle and nearby vehicle and/or other surrounding vehicles may also associate a time stamp representing the point at which they performed a localization of the dynamic object with a localization packet for the dynamic object.

Dynamic objects may be any type of moving object in a road region. For example, a dynamic object may be a pedestrian or a bicycle. A dynamic object can also be another vehicle that is not in direct communication with the ego vehicle and nearby vehicle and/or surrounding vehicles. Estimating a localization of a dynamic object and/or relative to a dynamic object may provide an additional layer of anonymity for the ego vehicle and nearby vehicle and/or surrounding vehicles since these vehicles may not need to share a localization relative to a global reference to improve localization estimates. Localizations of and/or relative to a dynamic objects may be shared instead of localizations relative to a global reference.

To improve a localization estimate for itself, a subject vehicle or ego vehicle may begin by estimating its own localization. The ego vehicle may estimate its own localization by estimating its vehicle coordinate frames relative to a global reference frame. Vehicle coordinate frames may be portions of a vehicle that can be detected from the outside of a vehicle. For example, vehicle coordinate frames may include the center of a vehicle's license plate. Vehicle coordinate frames may also include the center of a wheel of a vehicle or the center of an axel connecting two or more wheels.

After the ego vehicle has estimated its own localization, the ego vehicle may then identify a nearby dynamic object that it is able to detect and/or observe. The ego vehicle may then estimate the location of the nearby dynamic object. Specifically the ego vehicle may estimate the location of the nearby dynamic object relative to the same global reference frame it used to estimate its own location and may base its localization estimate for the dynamic object and its localization estimate for the ego vehicle itself. Additionally, and/or alternatively, the ego vehicle may estimate the localization of the dynamic object relative to the global localization of the ego vehicle itself.

For example, the ego vehicle may estimate its own localization by estimating the center of its license plate relative to a selected coordinate location corresponding to the center of the city in which the ego vehicle is driving. The ego vehicle may then detect a nearby dynamic object and perform an estimate of the localization of the dynamic object relative to the global localization estimate for the ego vehicle itself. The ego vehicle may also record a time stamp. The time stamp may refer to the point at which the ego vehicle detected and performing a localization estimate of the dynamic object.

The ego vehicle may then generate a localization packet based on the estimated localization of the dynamic object relative to a global reference. The estimated localization of the dynamic object may be based on the ego vehicle's determination of its own localization relative to a global reference and the ego vehicle's estimated localization of the dynamic object relative to the ego vehicle itself. A localization packet may include information that expresses the localization of the dynamic object relative to a global reference. A localization packet may also include a time stamp identifying the time at which the ego vehicle detected and performed a localization estimate of the dynamic object.

A localization packet may also contain additional information of a dynamic object. For instance a localization packet may contain dynamic object identification information. Dynamic object identification information may be a registration plate number, a vehicle color, a vehicle make, a vehicle model, and/or any other identifying information associated with a vehicle, if the dynamic object is a vehicle. Dynamic object identification information may also include information about the type of object, for instance a classification of whether the dynamic object is a pedestrian, cyclist, vehicle, or some other type of dynamic object. Dynamic object identification information may also include information about the size, shape, and other identifying features of a bicycle or pedestrian or other type of dynamic object.

A localization packet may also include additional information about the visual and/or physical features of each dynamic object. For instance, a localization packet may include image clips of the dynamic object(s). A localization packet may also include features useful for image processing, such as color/edge histograms and other types of features. A localization packet may also include 3D point clouds and/or dimensions for dynamic objects. The localization packet may also include a covariance for the estimated localization of each dynamic object representing the uncertainty associated with each such estimate.

Next, the ego vehicle may transmit or broadcast a corresponding generated localization packet or packets to a nearby vehicle and/or surrounding vehicles. The ego vehicle may transmit the packet(s) using, for example V2V communications. Alternatively, the ego vehicle may transmit the packet(s) over Wi-Fi, if available.

A nearby vehicle and/or surrounding vehicles may estimate the localization of both themselves and dynamic objects in the same way that the ego vehicle estimated the localization of itself and a nearby dynamic object and/or surrounding dynamic objects. The nearby vehicle and/or surrounding vehicles may generate a localization packet or localization packets for dynamic objects based on their localization estimates. The nearby vehicle and/or surrounding vehicles may then transmit the localization packet or localization packets to the ego vehicle using, for example, V2V communications or over Wi-Fi. The ego vehicle may then receive the localization packet and/or localization packets from the nearby vehicle and/or surrounding vehicles.

Next, the ego vehicle may refine its estimate of its own localization and/or the localizations of the nearby and/or surrounding dynamic objects based on the localization packet or packets generated by the nearby vehicle and/or surrounding vehicles. Specifically the ego vehicle may refine its estimate of its own localization and/or its estimate of the localization of a nearby dynamic object or surrounding dynamic objects based on the estimates of the localization of a nearby dynamic object or surrounding objects and time stamp(s) from a nearby vehicle and/or surrounding vehicles. In an embodiment, all localization estimates are relative in that they are based on a global reference frame and include relative estimates of localizations of dynamic objects. Therefore, the ego vehicle, nearby vehicle, and/or surrounding vehicles need not be related and need not directly share their own localization estimates.

An association method may be performed so that a vehicle receiving a localization packet is able to refine its estimate of its own location based on the localization packet containing information about the localization of a dynamic object. A vehicle's own estimated localization for the dynamic object may be compared with an estimate for the localization of a dynamic object received in a localization packet. The localization estimates may be compared as well as any covariance. The time stamps may also be compared so that localizations for the same dynamic object for the same point in time may be associated and/or compared. Two dimensional and/or three dimensional matching of the localization estimates for a dynamic object may be performed using information contained in the localization packet including localization estimates and covariance. A one-to-one association may be performed and/or confirmed by referring to semantic, visual, and/or physical information contained in the localization packet including, for example, the size and shape of the dynamic object and image clips of the dynamic object. For instance, if the dynamic object is a vehicle, license plate numbers may be compared to confirm the association. In another example, the dynamic object may be a pedestrian and a comparison of color histograms may be used to confirm the association.

In an embodiment, an ego vehicle and a plurality of nearby vehicles may perform and exchange localizations as discussed above. A determination may be made as to which vehicle, among the ego vehicle and nearby vehicles, is best equipped to accurately determine the localization of any given dynamic object or dynamic objects. In estimating the localization of a selected dynamic object, this approach may then afford more weight to the estimate of the vehicle that is best equipped to make an accurate estimate of the localization of the selected dynamic object. Different factors may influence whether a vehicle is able to make an accurate estimate including the type and sensitivity of sensors a vehicle is equipped with, the position of a vehicle relative to the dynamic object, and therefore the ability of a vehicle to fully or partially observe a dynamic object, the speed at which the vehicles are traveling relative to the dynamic objects, and any other factor that may influence the accuracy of a localization estimate.

Additionally, over time, the vehicle that is best able to make an accurate estimate may change. This may be due to changing conditions, such as weather, or a change in a vehicle route or trajectory. Additionally, surrounding infrastructure and changes in the roadway may alter which vehicle is best able to observe any given dynamic object. The system may then, in real time, revise the weight afforded to the localization estimate to prioritize the estimates of the vehicles with the greatest accuracy capability. Constant localization updates may be achieved and transmitted to connected vehicles over V2V, V2X, and/or wifi.

In an embodiment, connected vehicles performing, exchanging, and refining localization estimates, as discussed above may be able to communicate with and be integrated with a broader infrastructure. For example, in addition to localization methods and systems discussed above, connected vehicles could integrate with an RTK system including satellites and base stations, or a pre-constructed map system, when available. Localization estimates could be cross referenced and/or updated depending on the availability of integrated systems.

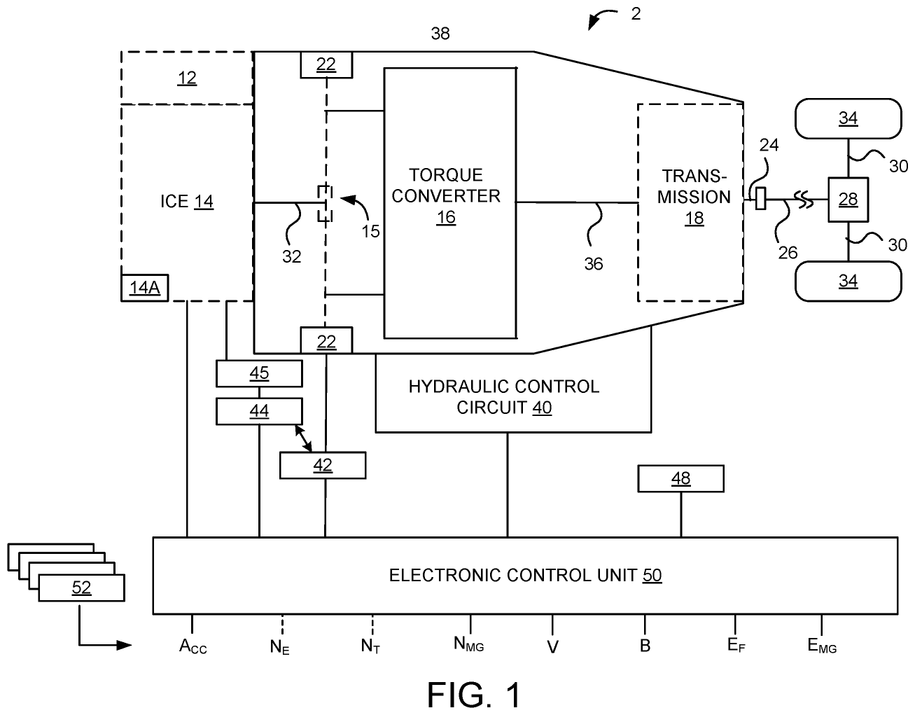

The systems and methods disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for improving the localization accuracy of a vehicle can be implemented in other types of vehicle including gasoline- or diesel-powered vehicles, fuel-cell vehicles, electric vehicles, or other vehicles.

FIG. 1 illustrates a drive system of a vehicle 102 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 102 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 102 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 102. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 102 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, proximity of nearby and/or surrounding vehicles, etc. Sensors 52 may also include cameras which may capture surroundings external to a vehicle.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, nearby vehicles, including the position and orientation of nearby vehicles, dynamic objects, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The examples of FIG. 1 are provided for illustration purposes only as examples of vehicle systems with which embodiments of the disclosed technology may be implemented. One of ordinary skill in the art reading this description will understand how the disclosed embodiments can be implemented with vehicle platforms.

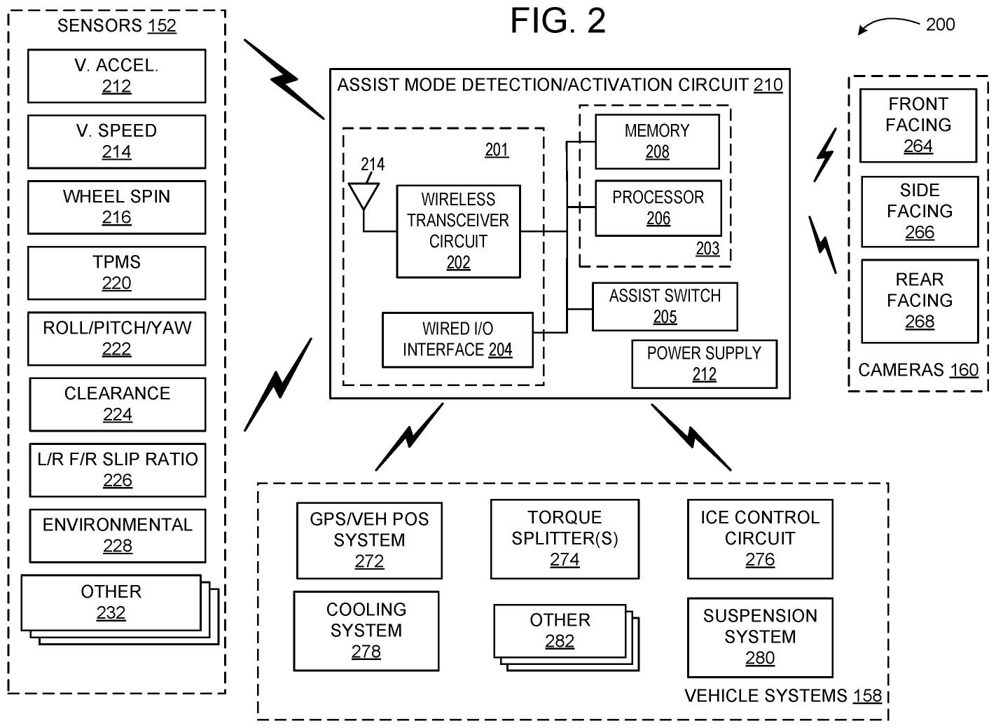

FIG. 2 illustrates an example architecture for improving vehicle localization accuracy in accordance with one embodiment of the systems and methods described herein. Referring now to FIG. 2, in this example, vehicle localization system 200 includes a localization improvement circuit 210, a plurality of sensors 152, and a plurality of vehicle systems 158. Sensors 152 and vehicle systems 158 can communicate with localization improvement circuit 210 via a wired or wireless communication interface. Although sensors 152 and vehicle systems 158 are depicted as communicating with localization improvement circuit 210, they can also communicate with each other as well as with other vehicle systems. Localization improvement circuit 210 can be implemented as an ECU or as part of an ECU such as, for example electronic control unit 50. In other embodiments, localization improvement circuit 210 can be implemented independently of the ECU.

Localization improvement circuit 210 in this example includes a communication circuit 201, a decision circuit (including a processor 206 and memory 208 in this example) and a power supply 212. Components of localization improvement circuit 210 are illustrated as communicating with each other via a data bus, although other communication in interfaces can be included. Localization improvement circuit 210 in this example also includes a manual assist switch 205 that can be operated by the user to manually select the assist mode.

Processor 206 can include a GPU, CPU, microprocessor, or any other suitable processing system. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208, can be made up of one or more modules of one or more different types of memory, and may be configured to store data and other information as well as operational instructions that may be used by the processor 206 to localization improvement circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a localization improvement circuit 210.

Communication circuit 201 either or both a wireless transceiver circuit 202 with an associated antenna 214 and a wired I/O interface 204 with an associated hardwired data port (not illustrated). As this example illustrates, communications with localization circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by localization improvement circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 210 can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 52 can include additional sensors that may or not otherwise be included on a standard vehicle 10 with which the vehicle localization system 200 is implemented. In the illustrated example, sensors 152 include vehicle acceleration sensors 212, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, and environmental sensors 228 (e.g., to detect salinity or other environmental conditions). Additional sensors 232 can also be included as may be appropriate for a given implementation of vehicle localization system 200.

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 they can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, and other vehicle systems.

During operation, localization improvement circuit 210 can receive information from various vehicle sensors to prepare/refine a localization packet. Communication circuit 201 can be used to transmit and receive information between localization improvement circuit 210 and sensors 152, and localization improvement circuit 210 and vehicle systems 158. Also, sensors 152 may communicate with vehicle systems 158 directly or indirectly (e.g., via communication circuit 201 or otherwise).

In various embodiments, communication circuit 201 can be configured to receive data and other information from sensors 152 that is used in determining whether to prepare/refine a localization packet. Additionally, communication circuit 201 can be used to send an activation signal or other activation information to various vehicle systems 158 as part of preparing and/or refining a localization packet. A localization packet may be prepared/refined based on information detected by one or more vehicles sensors 152.

Specifically, a vehicle may be equipped with cameras 160. These may include front facing cameras 264, side facing cameras 266, and rear facing cameras 268. Cameras may capture information which may be used in preparing and/or refining a localization estimate. For example, a front facing camera 264 may capture the license plate of a proximate vehicle in front of a vehicle equipped with front facing camera 264. Additionally, sensors may estimate proximity between vehicles. For instance, in addition to capturing the license plate/license plate information, the camera may be used with and/or integrated with additional sensors such as LIDAR sensors or any other sensors capable of capturing a distance.

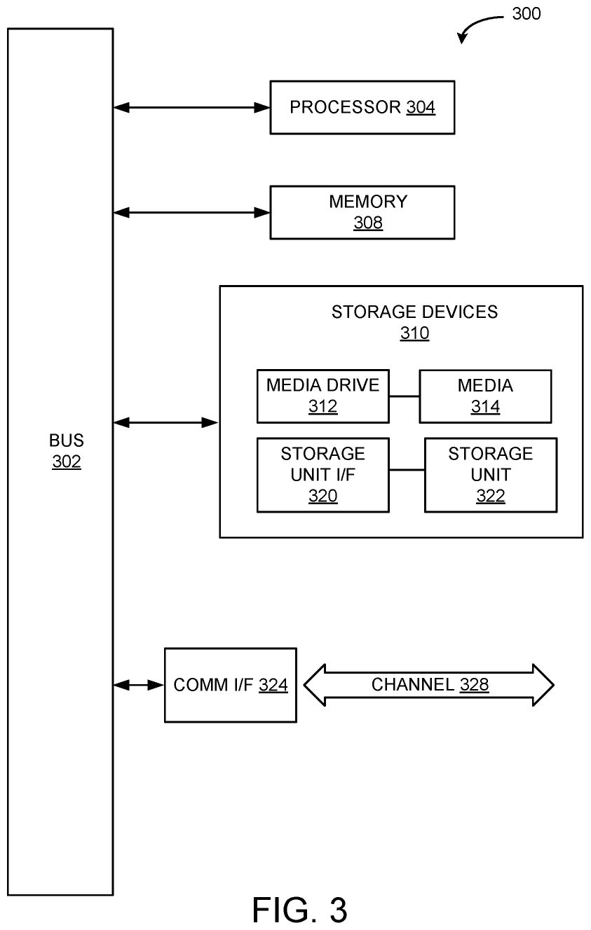

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 3. Various embodiments are described in terms of this example-computing component 300. After reading this description, it will become apparent to a person skilled in the relevant art how to implement the application using other computing components or architectures.

Referring now to FIG. 3, computing component 300 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 300 might also represent computing capabilities embedded within or otherwise available to a given device. For example, a computing component might be found in other electronic devices such as, for example, portable computing devices, and other electronic devices that might include some form of processing capability.

Computing component 300 might include, for example, one or more processors, controllers, control components, or other processing devices. This can include a processor, and/or any one or more of the components making up a user device, user system, and/or non-decrypting cloud service. Processor 304 might be implemented using a general-purpose or special-purpose processing engine such as, for example, a microprocessor, controller, or other control logic. Processor 304 may be connected to a bus 302. However, any communication medium can be used to facilitate interaction with other components of computing component 300 or to communicate externally.

Computing component 300 might also include one or more memory components, simply referred to herein as main memory 308. For example, random access memory (RAM) or other dynamic memory, might be used for storing information and instructions to be executed by processor 304. Main memory 308 might also be used for storing temporary variables or other intermediate information during execution of instructions to be executed by processor 304. Computing component 300 might likewise include a read only memory (“ROM”) or other static storage device coupled to bus 502 for storing static information and instructions for processor 304.

The computing component 300 might also include one or more various forms of information storage mechanism 310, which might include, for example, a media drive 312 and a storage unit interface 320. The media drive 312 might include a drive or other mechanism to support fixed or removable storage media 314. For example, a hard disk drive, a solid-state drive, a magnetic tape drive, an optical drive, a compact disc (CD) or digital video disc (DVD) drive (R or RW), or other removable or fixed media drive might be provided. Storage media 314 might include, for example, a hard disk, an integrated circuit assembly, magnetic tape, cartridge, optical disk, a CD or DVD. Storage media 314 may be any other fixed or removable medium that is read by, written to or accessed by media drive 312. As these examples illustrate, the storage media 314 can include a computer usable storage medium having stored therein computer software or data.

In alternative embodiments, information storage mechanism 310 might include other similar instrumentalities for allowing computer programs or other instructions or data to be loaded into computing component 300. Such instrumentalities might include, for example, a fixed or removable storage unit 322 and an interface 320. Examples of such storage units 322 and interfaces 320 can include a program cartridge and cartridge interface, a removable memory (for example, a flash memory or other removable memory component) and memory slot. Other examples may include a PCMCIA slot and card, and other fixed or removable storage units 322 and interfaces 320 that allow software and data to be transferred from storage unit 322 to computing component 300.

Computing component 300 might also include a communications interface 324. Communications interface 324 might be used to allow software and data to be transferred between computing component 300 and external devices. Examples of communications interface 324 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 324 may be carried on signals, which can be electronic, electromagnetic (which includes optical) or other signals capable of being exchanged by a given communications interface 324. These signals might be provided to communications interface 324 via a channel 328. Channel 328 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 308, storage unit 320, media 314, and channel 328. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 300 to perform features or functions of the present application as discussed herein.

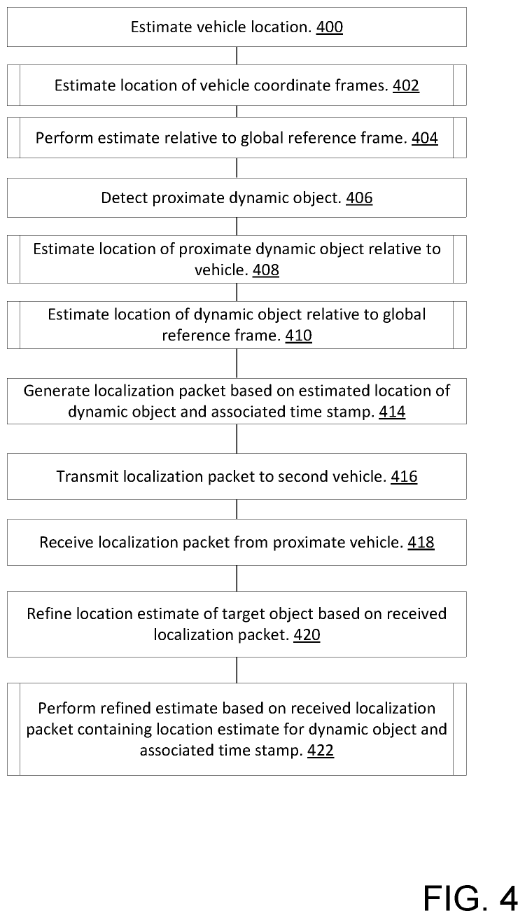

Referring now to FIG. 4, a method for improving the localization accuracy of a target object may include exchanging location estimates with a second vehicle and merging the exchanged estimates to refine localization estimates.

For instance, as a first operation 400, a subject vehicle or ego vehicle may first estimate its own location. This estimate may be of the location of selected vehicle coordinate frames of the ego vehicle. As a first sub-operation 402 to the first operation 400, the ego vehicle may estimate the location of vehicle coordinate frames for the ego vehicle. For example, the center of the license plate of the ego vehicle may be the selected coordinate frame. Other possible vehicle coordinate frames, including the center of a wheel or axel, or any other externally viewable portion of the vehicle may also be selected. Selecting a vehicle coordinate frame and estimating the location of the vehicle coordinate frame enables a more precise and accurate estimate of the vehicle's location. As a second sub-operation 404 to the first operation 400, the estimate of the ego vehicle's coordinate frames may be performed relative to a global reference frame. A global reference frame may be the center of the Earth or any other selected point either on a coordinate plane or with a physical significance, for instance a landmark.

As a second operation 406, an ego vehicle may then detect a proximate dynamic object. The dynamic object may share a portion of the road with the ego vehicle and may be observable by the ego vehicle. The dynamic object may be any object moving in the road. For example, the dynamic object may be a pedestrian, a cyclist, or another vehicle. As a first sub-operation 408 to the second operation 406, the ego vehicle may then estimate the location of the dynamic object relative to the ego vehicle. As a second sub-operation 410 to the second operation 406, the ego vehicle may then use the estimated location of the dynamic object relative to the ego vehicle, as determined in the first sub-operation 408 and the estimate of the ego vehicle relative to a global reference frame, as determined in operation 404, to estimate the location of the dynamic object relative to a global reference frame. The ego vehicle may also record a time stamp associated with the estimate of the location of the dynamic object.

As a third operation 414, the ego vehicle may then generate a localization packet based on its estimate of the location of the dynamic object and the time stamp associated with the estimate. For example, the generated localization packet may include a global location estimate for a pedestrian walking alongside the roadway and a time stamp capturing the point in time at which the ego vehicle estimated the global location of the pedestrian. The estimate may include degrees of certainty. The degree of certainty with which the ego vehicle is able to perform an estimate may depend on many factors including the proximity of the ego vehicle to the target object, the speed of travel of the ego vehicle and/or the target object, and any other relevant factors.

As a fourth operation 416, the ego vehicle may then transmit the generated localization packet to the second vehicle. As a fifth operation 418, the ego vehicle may in turn receive a localization packet from the second vehicle. As a sixth operation 420, the ego vehicle may then refine its localization estimates based on the localization packet received from the second vehicle. For example, in an embodiment, the ego vehicle may be the target object. As a sub-operation 422, to the sixth operation 420, the ego vehicle may then refine its estimate for its own localization based on the information received from the second vehicle. For instance, the ego vehicle may first refine its estimate for the dynamic object based on the received localization packet. Then, using its relative estimate of the dynamic object relative to its own location, the ego vehicle may in turn refine its estimate of its own localization. In another embodiment, the dynamic object may be the target object. The ego vehicle may then refine its estimate for the localization for the dynamic object based on the information received from the second vehicle.

Additionally, the ego vehicle and the second vehicle may be differently able to accurately determine a localization. For example, the ego vehicle may be able to estimate a localization with an uncertainty of 10 millimeters. However, the second vehicle may be able to estimate localization with an uncertainty of 1 millimeter. Because the second vehicle is better equipped to precisely and accurately estimate a localization, the ego vehicle may afford the second vehicle's localization more weight than its own localization estimates in refining its localization estimates.

In an embodiment, both the ego vehicle and the second vehicle may be able to estimate localization with an uncertainty at the millimeter level or better. Precise localization estimates achieved by the systems and methods disclosed herein offer advantageous over less precise methods. For instance, a precise estimate may support many desirable autonomous driving functions while a less precise estimate may only be suitable for navigation and similar functions.

In an embodiment, the entire estimate and refinement method is performed in real-time. Between the ego vehicle and the second vehicle, the vehicle best equipped to accurately estimate the localization may vary with changing circumstances. Therefore, updated real-time localization packets may be exchanged on a continuous basis and may leverage differently weighted localization estimates to provide a constant, accurate, real-time localization estimate of the target object.

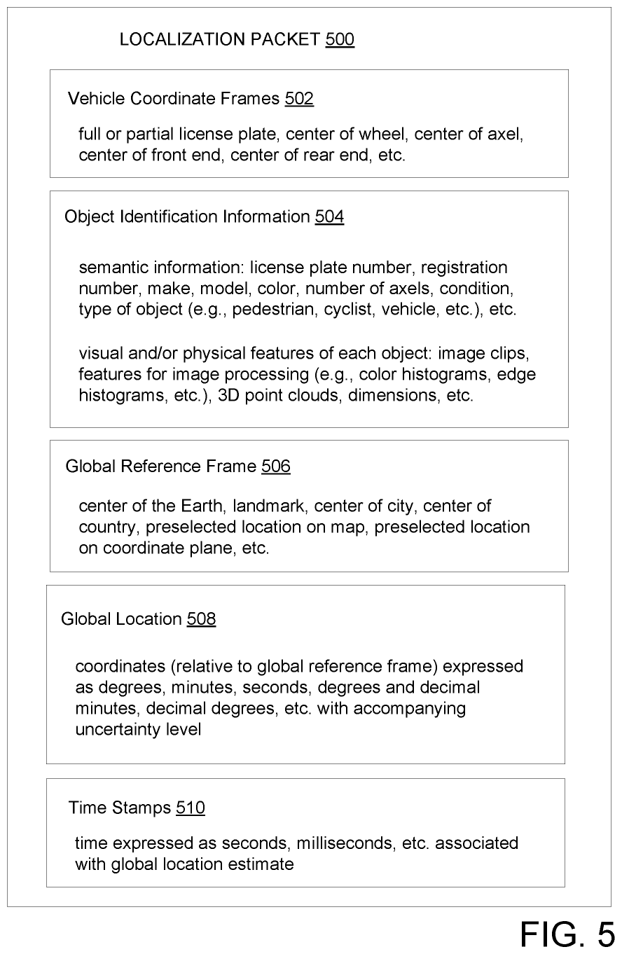

Referring now to FIG. 5, is an example of a localization packet 500. A localization packet 500 may include several types of information including vehicle coordinate frames 502, object identification information 504, global reference frame information 506, a global location estimate 508, and a time stamp 510. Localization packet 500 may also contain any other useful information including additional information about other nearby vehicles and/or entities, information about nearby infrastructure, pre-constructed maps, roadway condition information, weather information, and any other information that may be useful.

Vehicle coordinate frames 504 include points on the vehicle that can be observed external to the vehicle such that a precise and accurate location estimate for the vehicle may be made. Vehicle coordinate frames may include, for example, the center of the license plate or registration plate of a vehicle, the center of a particular wheel, such as the front left or right or rear left or right wheel, the center of the axel of a wheel, the center of the front end or front bumper of a vehicle, the center of the rear end or rear bumper of a vehicle, the center of the vehicle lengthwise, or any other information that can be used to form an accurate and precise estimate of the location and orientation of the vehicle.

Object identification information 504 includes any information that can be used to identify a particular object and/or distinguish an object from surrounding objects. object identification information 504 may include, for example, the license plate number of a vehicle, the VIN, the registration number, the year, make, and/or model of a vehicle, the color of a vehicle, the condition a vehicle is, the state in which a vehicle is registered, the number of axels the vehicle has, and any other information that may be used to identify a vehicle and/or distinguish it from other vehicles on the road, if the object is a vehicle.

Object identification information 504 may also include semantic information associated with objects which may include the color of an object and the type of an object. For instance, an object may be a vehicle but it may also be a pedestrian, a cyclist, or some other object moving in a road area. For instance, the color and type of bicycle may be included in semantic information in the localization packet 600 and may be useful in distinguishing a bicycle or confirming a bicycle detected by a first vehicle is the same bicycle detected by a second vehicle.

Object identification information 504 may also include visual and/or physical characteristics of an object that may be useful in identifying an object or interpolating or extrapolating location estimates of an object measured by two different vehicles to determine a location estimate for the same point in time. Visual and/or physical features may include image clips, features for image processing such as color histograms, edge histograms, and other information, 3D point clouds, dimensions, and other useful information.

Global reference frame 506 includes any selected frame that can serve as a relative reference for a vehicle location estimate. For example, a global reference frame 506 may include the center of the Earth, a physical landmark, the center of a particular city or county, any preselected location on a map, any preselected location on a coordinate plane, or any other selected point from which the location of the vehicle may be estimated.

A global location estimate 508 may be the location estimate for the ego vehicle itself, a second vehicle, or a dynamic object. The global location estimate 508 may be expressed in coordinates relative to the global reference frame. The global location estimate 508 may be expressed as degrees, minutes, seconds, degrees and decimal minutes, decimal degrees, and/or in any other format that can accurate represent the localization of a vehicle relative to a global reference frame. The global location estimate 508 may also have an uncertainty level. The uncertainty level may indicate the degree of accuracy of the global location estimate 508. The uncertainty level may vary with varying circumstances. For instance, the uncertainty level may increase as vehicle speed increases in an embodiment. The global location as well as the associate uncertainty may both vary over time and accurate, precise, real-time estimates may be performed on a continuous basis.

A time stamp 510 may be the exact time associated with a location estimate for a dynamic object or other object. The time stamp 510 may be expressed at the second or millisecond level. The time stamp 510 may also have an uncertainty level. The uncertainty level may indicate the degree of accuracy of the association between the time stamp and the location estimate. The uncertainty level may vary with varying circumstances. For instance, the uncertainty level may increase as vehicle speed increases in an embodiment. The time stamp may be used to estimate the location of a dynamic object at a selected time when two or more vehicles each detect the dynamic object and estimate its location but the vehicles detect the dynamic object and perform their estimates at different times. A dynamic object may not be mutually observable to two or more vehicles at the exact same time but may be observable by two or more vehicles at different times.

Note that while the ego vehicle may perform localization estimates for both itself and the dynamic object, the second vehicle may likewise perform estimates for both itself and the dynamic object. Thus, from the second vehicle's perspective, the second vehicle is the ego vehicle. Therefore, the second vehicle's localization packet 500 may include a global location estimate for itself as well as a global location estimate for the dynamic object. Alternatively localization packets may be limited to location estimates for the dynamic object only to preserve anonymity of the vehicles.

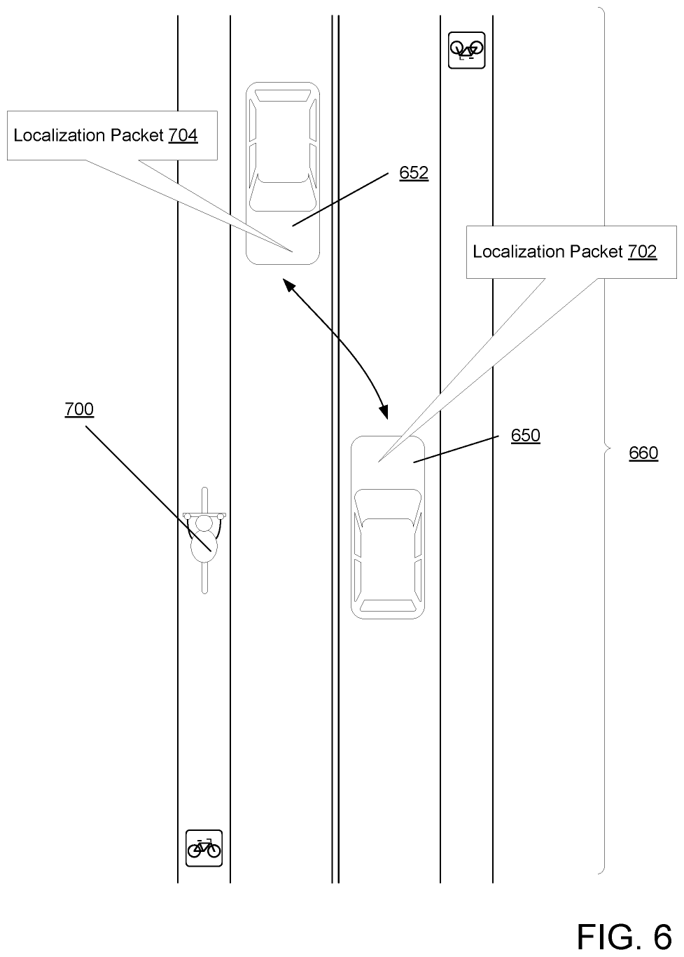

Referring now to FIG. 6, an example of a system including an ego vehicle 650, a second vehicle 652, and a dynamic object 700 is shown. The ego vehicle 650 may estimate its own location in accordance with the embodiments described herein. The ego vehicle may then detect the dynamic object 700. The ego vehicle and dynamic object may share a road region 660. The ego vehicle 650 may be able to detect the dynamic object 700. In FIG. 6, the ego vehicle 650 may have been able to observe the dynamic object head on in the recent past. In FIG. 6 the ego vehicle 650 is shown passing the dynamic object 700. In FIG. 6, the dynamic object 700 is a cyclist. In other embodiments, the dynamic object 700 may be a pedestrian, a vehicle, or some other object. In FIG. 6, the dynamic object 700 may be directly observable by the second vehicle 652. The second vehicle 652 may be approaching or passing the dynamic object 700. Other configurations, though not shown in FIG. 6, are also possible. The ego vehicle 650 may also be able to communicate with the second vehicle 652.

The ego vehicle 650 may be able to estimate a location for the dynamic object 700 based on its estimate of its own location. For example, the ego vehicle 650 may be able to detect the dynamic object 700, using, for example, front facing cameras, LIDAR sensors, and/or any other cameras and/or sensors. The ego vehicle 650 may estimate the location of the dynamic object 700 relative to its own location. The ego vehicle may then estimate the location of the dynamic object 700 relative to a global reference frame based on the ego vehicle's estimate of its own location and the ego vehicle's estimate of the location of the dynamic object 700 relative to the location of the ego vehicle 650.

The ego vehicle 650 may also record a time stamp. The time stamp may be associated with the ego vehicle's estimate of the location of the dynamic object 700 relative to a global reference frame. The time stamp may reflect the point in time at which the ego vehicle 650 estimated the location of the dynamic object 700. For example, the ego vehicle 650 may have performed an estimate of the location of the dynamic object 700 just prior to arriving at the configuration shown in FIG. 6, since the ego vehicle 650 is shown passing the dynamic object 700 in FIG. 6.

The second vehicle 652 may in turn be able to estimate a location for the dynamic object 700 based on its estimate of its own location. For example, the second vehicle 652 may be able to detect the dynamic object 700, using, for example, front facing cameras, LIDAR sensors, and/or any other cameras and/or sensors. The second vehicle 652 may estimate the location of the dynamic object 700 relative to its own location. The second vehicle 652 may then estimate the location of the dynamic object 700 relative to a global reference frame based on the second vehicle's estimate of its own location and the second vehicle's estimate of the location of the dynamic object 700 relative to the location of the second vehicle 652.

The second vehicle 652 may also record a time stamp. The time stamp may be associated with the second vehicle's estimate of the location of the dynamic object 700 relative to a global reference frame. The time stamp may reflect the point in time at which the second vehicle 652 estimated the location of the dynamic object 700. For example, the second vehicle 652 be actively performing an estimate of the location of the dynamic object 700 in the configuration shown in FIG. 6, since the second vehicle 652 is shown approaching the dynamic object 700 in FIG. 6.

The ego vehicle 650 may transmit a localization packet 702 to the second vehicle 652 containing a localization estimate for the dynamic object 700, a time stamp associated with its estimate, and any other relevant information including object identification information. The second vehicle 652 may likewise transmit a localization packet 704 to the ego vehicle 650, containing an estimate of the localization of the dynamic object, a time stamp associated with the estimate, and any other relevant information, including object identification information. Note that because the localization estimates are performed relative to a global reference frame, the ego vehicle and second vehicle need not reveal their absolute locations to each other to perform improved localizations, as discussed herein.

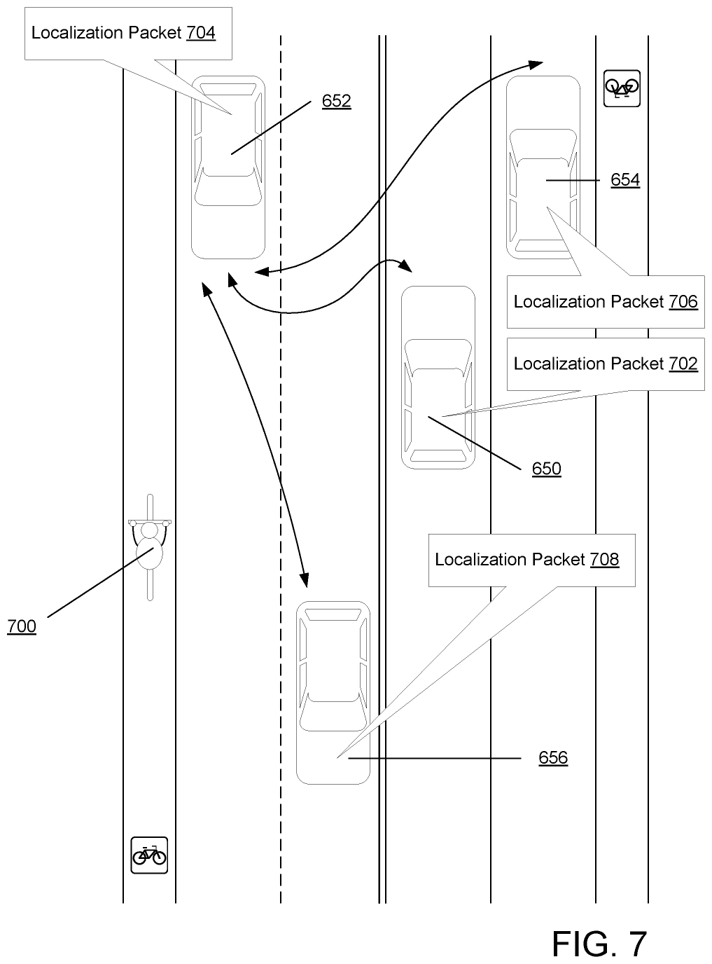

Referring now to FIG. 7, an example of a system including an ego vehicle 650 and a plurality of additional vehicle 652, 654, 656 is shown. The ego vehicle 650 may estimate its own location in accordance with the embodiments described herein. The ego vehicle may then detect the dynamic object 700. The ego vehicle and dynamic object may share a road region 660. The ego vehicle 650 may be able to detect the dynamic object 700. In FIG. 7, the ego vehicle 650 may have been able to observe the dynamic object head on in the recent past. In FIG. 7 the ego vehicle 650 is shown passing the dynamic object 700. In FIG. 7, the dynamic object 700 is a cyclist. In other embodiments, the dynamic object 700 may be a pedestrian, a vehicle, or some other object. In FIG. 7, the dynamic object 700 may be directly observable by a second vehicle 652. The second vehicle 652 may be approaching or passing the dynamic object 700. Other configurations, though not shown in FIG. 7, are also possible. The ego vehicle 650 may also be able to communicate with the second vehicle 652.

The ego vehicle 650 may be able to estimate a location for the dynamic object 700 based on its estimate of its own location. For example, the ego vehicle 650 may be able to detect the dynamic object 700, using, for example, front facing cameras, LIDAR sensors, and/or any other cameras and/or sensors. The ego vehicle 650 may estimate the location of the dynamic object 700 relative to its own location. The ego vehicle may then estimate the location of the dynamic object 700 relative to a global reference frame based on the ego vehicle's estimate of its own location and the ego vehicle's estimate of the location of the dynamic object 700 relative to the location of the ego vehicle 650.

The ego vehicle 650 may also record a time stamp. The time stamp may be associated with the ego vehicle's estimate of the location of the dynamic object 700 relative to a global reference frame. The time stamp may reflect the point in time at which the ego vehicle 650 estimated the location of the dynamic object 700. For example, the ego vehicle 650 may have performed an estimate of the location of the dynamic object 700 just prior to arriving at the configuration shown in FIG. 6, since the ego vehicle 650 is shown passing the dynamic object 700 in FIG. 7.

The ego vehicle may identify additional vehicles 652, 654, 656. The ego vehicle 650 and additional vehicles 652, 654, 656 may share a road region 660. The additional vehicles 652, 654, 656 may in turn be able to estimate a location for the dynamic object 700 based on their respective estimate of their own locations. For example, the additional vehicles 652, 654, 656 may be able to detect the dynamic object 700, using, for example, front facing cameras, LIDAR sensors, and/or any other cameras and/or sensors. The additional vehicles 652, 654, 656 may estimate the location of the dynamic object 700 relative to their own respective location. The additional vehicles 652, 654, 656 may then estimate the location of the dynamic object 700 relative to a global reference frame based on the additional vehicles' 652, 654, 656 respective estimates of their own location and the additional vehicles' 652, 654, 656 estimates of the location of the dynamic object 700 relative to their respective locations.

The additional vehicles 652, 654, 656 may also record time stamps. The time stamps may be associated with the additional vehicles' 652, 654, 656 respective estimates of the location of the dynamic object 700 relative to a global reference frame. The time stamps may reflect the point in time at which each additional vehicle 652, 654, 656 estimated the location of the dynamic object 700. For example, one of the additional vehicles 652 be actively performing an estimate of the location of the dynamic object 700 in the configuration shown in FIG. 7, since the additional vehicle 652 is shown approaching the dynamic object 700 in FIG. 7.

The ego vehicle 650 may transmit a localization packet 702 to the second additional vehicles 652, 654, 656 containing a localization estimate for the dynamic object 700, a time stamp associated with its estimate, and any other relevant information including object identification information. The additional vehicles 652, 654, 656 may likewise transmit additional localization packets 704, 706, 708 to the ego vehicle 650, containing estimates of the localization of the dynamic object, time stamps associated with the estimate, and any other relevant information, including object identification information. Note that because the localization estimates are performed relative to a global reference frame, the ego vehicle and additional vehicles need not reveal their absolute locations to each other to perform improved localizations, as discussed herein.

As shown in FIG. 7, one embodiment of a system for improved vehicle localization may include multiple vehicles. Each vehicle may include an uncertainty for its localization estimates in its localization packet. Each vehicle's ability to accurately and precisely estimate its own location as well as the locations of dynamic objects may vary. As such, the uncertainty estimates for each location for each object as determined by each vehicle may vary. Additionally, a vehicle's ability to accurately estimate localization may be static. For example, a vehicle may be equipped with older and/or less sensitive sensors and cameras which may impeded its ability to accurately estimate localization. However, a vehicle's ability to accurately estimate localization may also vary with changing circumstances. Therefore, at any point in time, the vehicle among the plurality of vehicles best equipped to accurately estimate the localization of any object may vary.

Therefore, a system and/or method for improving localization accuracy may include a weighted estimate giving the estimate(s) of the vehicle best equipped to accurately measure localization the most weight and giving the vehicle least equipped to accurately measure localization the least weight. Since the vehicle best equipped to accurately measure localization may change over time, the system/method may in real-time continuously update localization packets and estimates and make continuously refine an estimate of a target object in real-time. This type of real-time, high accuracy localization estimate may be extremely sensitive and may achieve localization estimates to a 1 meter or better level of certainty. This type of precise localization estimate may support autonomous driving functions and application.

In an embodiment, the method and systems disclosed herein may be used independently. For example, they may be used in an uncharted urban tunnel area where GPS-based methods may fail due to lack of signal and pre-constructed map methods may fail due to a lack of pre-constructed map. However, in another embodiment, the systems and methods disclosed herein may be integrated with a GPS, RTK, and/or satellite based methods and/or with a pre-constructed map-based localization methods. For example, localization estimates may be shared with surrounding infrastructure and/or other vehicles via Wi-Fi, V2V, and/or V2X communication methods or other communication methods where available. Additionally, pre-constructed map and/or satellite-based localization estimates may serve as a reference and/or refinement tool for localization estimates.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for improving localization accuracy of a target object comprising:
estimating a location of a first vehicle relative to a global reference frame;
detecting a dynamic object proximate to the first vehicle;
estimating a location of the dynamic object relative to the location of the first vehicle;
estimating a location of the dynamic object relative to the global reference frame based on the estimated location of the first vehicle;
receiving a localization packet from a second vehicle, wherein the localization packet is generated by the second vehicle based on the second vehicle's estimated location of the dynamic object and a time stamp associated with the second vehicle's estimated location of the dynamic object; and
refining the estimate of the location of the target object.

2. The method of claim 1 wherein the target object is the first vehicle and wherein refining the estimate of the location of the target object comprises:
refining the estimate of the dynamic object based on the received localization packet; and
refining the estimate of the location of the first vehicle based on the refined estimate of the location of the dynamic object.

3. The method of claim 1 wherein the target object is the dynamic object and wherein refining the estimate of the location of the target object comprises refining the estimate of the location of the dynamic object based on the received localization packet.

4. The method of claim 1 wherein the dynamic object is selected from the group consisting of: a pedestrian, a cyclist, and a vehicle.

5. The method of claim 1 wherein the global reference frame comprises the origin of a selected coordinate plane.

6. The method of claim 1 wherein the global reference frame comprises the center of the Earth.

7. The method of claim 1 further comprising:
generating a localization packet based on the first vehicle's estimated location of the dynamic object and a time stamp associated with the first vehicle's estimated location of the dynamic object; and
transmitting the generated localization packet to the second vehicle.

8. The method of claim 7 wherein transmitting the generated localization packet to the second vehicle comprises transmitting the generated localization packet using vehicle-to-vehicle (V2V) communications.

9. The method of claim 7 wherein transmitting the generated localization packet to the second vehicle comprises transmitting the generated localization packet using Wi-Fi.

10. The method of claim 7 further comprising performing an association for the dynamic object by estimating a location of the dynamic object relative to a global reference frame at a shared point in time based on the first vehicle's estimated location of the dynamic object and the time stamp associated with the first vehicle's estimated location of the dynamic object and the second vehicle's estimated location of the dynamic object and the time stamp associated with the second vehicle's estimated location of the dynamic object.

11. The method of claim 7 wherein the generated and received localization packets each contain identification information associated with the dynamic object.

12. The method of claim 11 further comprising performing an association for the dynamic object by matching the identification information associated with the dynamic objected contained in the generated and received localization packets.

13. The method of claim 7 further comprising:
identifying additional vehicles proximate to the dynamic object;
transmitting the generated localization packet to the additional vehicles;
receiving additional localization packets from each additional vehicle, wherein each additional localization packet is generated, respectively, by each additional vehicle and is based on, respectively, each additional vehicle's estimated location of the dynamic object and a time stamp associated with each additional vehicle's estimate location of the dynamic object; and
refining the estimate of the location of the target object.

14. The method of claim 13 further comprising:
determining which vehicle, among the first vehicle, second vehicle, and additional vehicles, is best equipped to accurately determine the location of the target object;
affording greater weight to the localization estimate of the vehicle best equipped to accurately estimate the location of the target object; and
refining the estimate of the location of the target object based on the weighted generated, received, and additional localization packets.

15. The method of claim 14 further comprising:
repeating the determination of which vehicle, among the first vehicle, second vehicle, and additional vehicles, is best equipped to accurately determine the location of the target object;
affording greater weight to the localization estimate of the vehicle best equipped to accurately determine the location of the target object; and
again refining the estimate of the location of the target object based on the weighted generated, received, and additional localization packets.

16. A localization system comprising:
a first vehicle wherein the first vehicle is:
equipped with advanced safety systems (ADAS);
able to estimate its location; and
able to communicate with other vehicles;
a dynamic object detected by the first vehicle as proximate to the first vehicle;
a second vehicle proximate to the dynamic object, wherein the second vehicle is:
equipped with ADAS;
able to estimate its location; and
able to communicate with other vehicles;
wherein the first vehicle estimates a global location of the first vehicle, estimates a first location of the dynamic object relative to the location of the first vehicle, and estimates a global location of the dynamic object based on the global estimate location of the first vehicle and the first relative estimate of the dynamic object;
wherein the second vehicle estimates a global location of the second vehicle, estimates a second location of the dynamic object relative to the location of the second vehicle, and estimates a global location of the dynamic object based on the global estimate location of the second vehicle and the second relative estimate of the dynamic object;
a first localization packet, wherein the first localization packet is generated by the first vehicle based on the first estimated global location of the dynamic object and a first time stamp at which the first vehicle detected the dynamic object; and
a second localization packet, wherein the second localization packet is generated by the second vehicle based on the second estimated global location of the dynamic object and a second time stamp at which the second vehicle detected the dynamic object;
wherein the first and second vehicles exchange the first and second localization packets;
and wherein the first and second vehicles each refine their estimated global locations for both the first vehicle and the second vehicles, respectively, and the dynamic object based on the received localization packets.

17. The system of claim 16 wherein the estimated global locations of the first and the second vehicles and the dynamic object, including the first and second localization packets, each include an uncertainty range.

18. The system of claim 17 wherein the first and second vehicles take the uncertainty ranges into account in refining their estimated global locations for the first vehicle and the second vehicle, respectively, and the dynamic object based on the received localization packets.

19. The system of claim 16 further comprising GPS receivers, wherein the GPS receivers support real-time kinematic (RTK) positioning, and wherein the system cross references localization packets with localization estimates determined by the GPS receivers to refine localization estimates.

20. The system of claim 16 further comprising pre-constructed maps of driving areas, wherein the pre-constructed maps support relative localization estimates, and wherein the system cross references localization packets with localization estimates performed by referencing the pre-constructed maps.
